(19) United States
(12) Patent Application Publication
(10) Pub. No.: US 2011/0021309 A1
(43) Pub. Date: Jan. 27, 2011

(54) BEARING ARRANGEMENT FOR THE ROTATABLE MOUNTING OF A PLANET GEAR ON A PLANET CARRIER

(75) Inventor: Tim Loeshner, Wuerzburg (DE)

Correspondence Address: LUCAS & MERCANTI, LLP, 475 PARK AVENUE SOUTH, 15TH FLOOR, NEW YORK, NY, 10016, US

(73) Assignee: SCHAEFFLER KG, Herzogenaurach (DE)

(21) Appl. No.: 12/513,270

(22) PCT Filed: Oct. 30, 2007
(86) PCT No.: PCT/DE07/01949

§ 371 Date: Nov. 19, 2009

(30) Foreign Application Priority Data
Nov. 3, 2006 (DE) 10 2006 051 817.9

(51) Int. Cl. F16C 19/24

(52) U.S. Cl. 475/348

(57) ABSTRACT

A bearing arrangement for rotatable mounting of a planet gear on a planet carrier, which has two tapered roller bearings arranged with an axial spacing to one another. In order to increase the load capacity of the bearing arrangement, at least one radial bearing is arranged in the space remaining between the tapered roller bearings. The radial bearing can be embodied as a cylindrical roller bearing, a needle bearing, a ball bearing or as a plain bearing. In order to distribute the load capacity of the bearing arrangement uniformly, the radial bearing, which is arranged between the tapered roller bearings, is adjustable with regard to the bearing play or a bearing preload.

### FIELD OF THE INVENTION

The invention relates to a bearing arrangement for the rotatable mounting of a planet wheel on a planet carrier, with two tapered roller bearings arranged with an axial spacing with respect to one another.

### BACKGROUND OF THE INVENTION

Planetary gear trains are increasingly used in applications where high forces and torques are transferred and at the same time as low a design weight or transmission weight as possible is required. A typical application for planetary gear trains of this type are transmissions for wind power installations. Very high, sometimes even insufficiently known forces and torques act on these while they are in operation. Since these transmissions are arranged at the tip of high towers which are often exposed to strong, changing winds and operating loads, a reduction in the weight of the transmissions is particularly important here, since the strength requirements for such a tower or rotor mast are thereby also lowered.

EP 1 252 442 B1 already discloses a bearing arrangement of the type mentioned in the preamble of claim 1, in which the mounting of a planet gear on the assigned planet carrier takes place via two tapered roller bearings arranged with a spacing with respect to one another. The mutual spacing of the tapered roller bearings results, in a design layout, from the bending moments transferred from the planet wheel to the planet carrier. Between the tapered roller bearings, an unused space remains which does not contribute anything to the load-bearing capacity of the transmission, but enlarges the required construction space.

### OBJECT OF THE INVENTION

The object on which the invention is based is to provide a bearing arrangement of the type mentioned in the preamble of claim 1, in which the construction space determined by stipulated load assumptions is utilized optimally for the purpose of the highest possible load-bearing capacity of the bearing arrangement.

### SUMMARY OF THE INVENTION

The invention is based on the realization that the space between the two tapered roller bearings can be utilized for accommodating further bearing elements, in order to thereby increase the load-bearing capacity of the bearing arrangement, without the construction space being enlarged.

The invention therefore proceeds from a bearing arrangement for the rotatable mounting of a planet gear on a planet carrier, with two tapered roller bearings arranged with an axial spacing with respect to one another. In this case, according to the invention, there is provision for one or more radial bearings to be arranged between the tapered roller bearings.

By a combination of two tapered roller bearings and one or more radial bearings arranged axially between them, the available construction space in the transmission is utilized optimally and the load-bearing capacity or the load-bearing coefficient of the bearing arrangement is increased. Since the radial bearing or radial bearings relieves or relieve the tapered roller bearings, the service life of the latter and consequently the service life of the overall bearing arrangement are improved. The tapered roller bearings basically prevent a tilting of the planet gear on the planet carrier and consequently a reduction in the service life of these bearings. The radial bearing or radial bearings additionally absorbs or absorb forces which would otherwise load the tapered roller bearings.

According to a preferred embodiment of the invention, there is provision for a radial bearing to fill the axial interspace between the tapered roller bearings, which is determined essentially by the bending moments acting on the planet carrier, that is to say as far as possible utilizes the existing structurally determined construction space.

In a structural embodiment of the invention, there is provision for the tapered roller bearings to be designed and arranged such that the axes of rotation of the tapered rollers intersect one another between the tapered roller bearings and radially within the raceways of the tapered rollers, as is also stated in detail by means of an exemplary embodiment.

According to one embodiment of the invention, a radial bearing is designed as a cylindrical roller bearing. Cylindrical roller bearings are simple and proven bearings which are commercially available in various dimensions and for different loads and can consequently be obtained at low cost.

Other embodiments of the invention provide for the radial bearing to be designed as a needle bearing or as a ball bearing.

In order to achieve a uniform load distribution over the at least three bearing rows, various methods or devices are available. If the radial bearing or radial bearings is or are designed as rolling bearings, the rolling bodies can be sorted, that is to say all the rolling bodies of a bearing can be assembled, such as to give rise to a load-bearing pattern which is uniform over the circumference.

According to another embodiment of the invention, there is provision for the inner bearing ring of a radial bearing to be adjustable in terms of the bearing play or of the bearing prestress. For this purpose, for example, the inner face of the inner ring of the radial bearing is designed conically and is seated on an axially displaceable sleeve having a complementarily conical outer face. As a result of the axial displacement of the sleeve, the inner ring of the radial bearing can be widened radially, and consequently the bearing play or bearing prestress can be set.

Another refinement provides for the inner ring of the radial bearing to be seated on a rotatable eccentric ring. By the eccentric ring being rotated, the eccentricity of the radial bearing can be adjusted in the circumferential direction and therefore the radial bearing can be braced against the tapered roller bearings.

Moreover, it may be advantageous that the planet gear has formed on it a radially inward-pointing annular web, of which the radially inward-pointing surface area is supported on the radially outer surface area of the outer ring of the radial bearing.

In order to make assembly easier and to reduce the costs of the bearing arrangement, according to a further embodiment of the invention there is provision for the two tapered roller bearings and the radial bearing or radial bearings to have a common outer ring.

In addition to the radial bearing being designed as a rolling bearing, a design as a plain bearing is also possible.

A bearing arrangement according to the invention can be used highly advantageously as a component of a planetary gear stage of a wind turbine transmission arrangement and is designed accordingly.

### BRIEF DESCRIPTION OF THE DRAWINGS

The invention is explained in more detail below by means of several embodiments, with reference to the accompanying drawing in which:

FIG. 1 shows schematically a longitudinal section through a bearing arrangement with two tapered roller bearings and with one cylindrical roller bearing;

FIG. 2 shows schematically a partial longitudinal section through a bearing arrangement with two tapered roller bearings and with one cylindrical roller bearing and also with an outer ring common to all three bearings;

FIG. 3 shows an arrangement similar to that in FIG. 2, with a device for setting the bearing play of the cylindrical roller bearing; and

FIG. 4 shows a cross-section through a bearing arrangement with a device for adjusting the eccentricity.

### DETAILED DESCRIPTION OF THE DRAWINGS

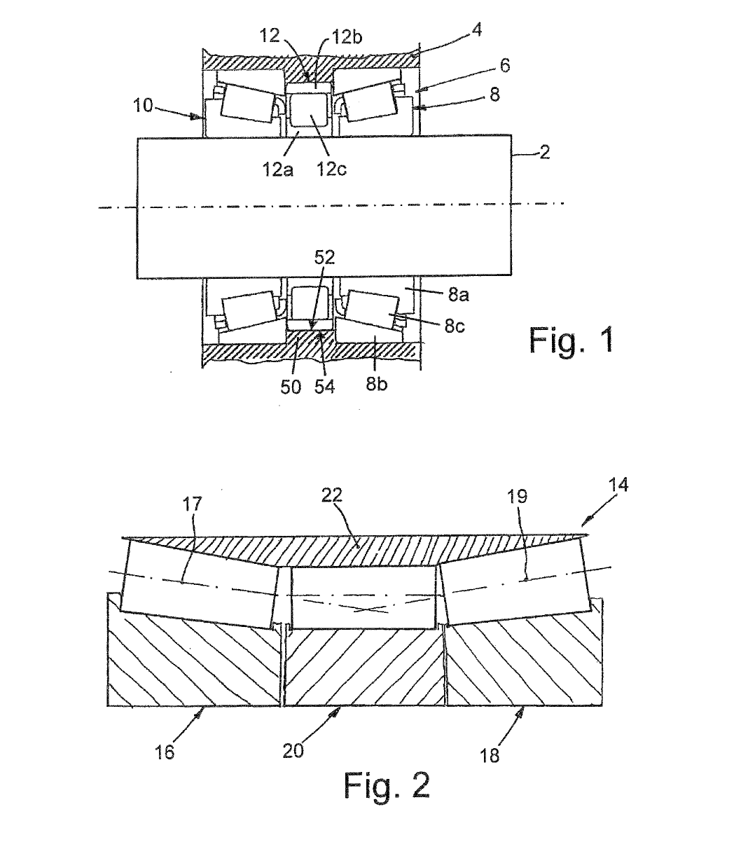

FIG. 1 shows a planet carrier 2, on which a planet wheel 4 is mounted rotatably via a special bearing arrangement 6. The bearing arrangement 6 comprises two tapered roller bearings 8 and 10, arranged with an axial spacing with respect to one another and having tapered rolling bodies 8c, and a radial bearing 12 arranged between the tapered roller bearings 8, 10. In FIG. 1, the radial bearing 12 is designed as a cylindrical roller bearing and has an inner ring 12a, an outer ring 12b and cylindrical rolling bodies 12c arranged between them. As can be seen in FIG. 1, the radial bearing 12 fills essentially the entire space remaining between the tapered roller bearings 8, 10. The tapered roller bearings 8, 10 and the radial bearing 12 are each independent bearings in which each of these bearings is equipped with a separate inner bearing ring 8a, 12a and with a separate outer bearing ring 8b, 12b, as may be gathered directly from FIG. 1.

Advantageously, the planet wheel 4 has formed on it a radially inward-pointing annular web 50, of which the radially inward-pointing surface area 52 is supported on the radially outer surface area 54 of the outer ring 13 of the radial bearing 12.

FIG. 2 shows a partial longitudinal section through a bearing arrangement 14 which, as in the example of FIG. 1, comprises two tapered roller bearings 16 and 18 and also a radial bearing 20 arranged between them and designed as a cylindrical roller bearing. In contrast to the bearing arrangement illustrated in FIG. 1, these three bearings 16, 18, 20 have a common outer ring 22 which, in particular, simplifies the assembly of the bearing arrangement. As can be seen further from FIG. 2, the axes of rotation 17 and 19 of the tapered rollers intersect one another between the tapered roller bearings 16 and 18 and radially within the ideal raceways of the tapered rollers (that is to say, the passages of movement of the axes of rotation 17, 19).

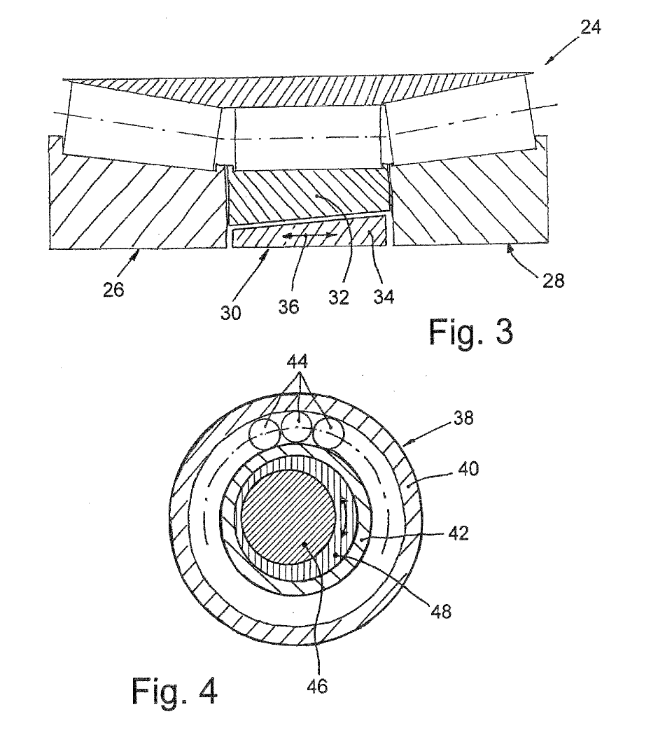

FIG. 3 shows a bearing arrangement 24 similar to that in FIG. 2, with two tapered roller bearings 26 and 28 and with a radial bearing 30 arranged between these and designed as a cylindrical roller bearing. In order to achieve a uniform load distribution over the three bearing rows, the inner bearing ring 32 of the radial bearing 30 is mounted on a conical sleeve 34 displaceable in the direction of the arrow 36 (axial direction). As a result of the displacement of the conical sleeve 34, the inner bearing ring 32 can be widened to a greater or a lesser extent, and consequently the play of the radial bearing 30 or its prestress can be set.

FIG. 4 shows a cross section through a cylindrical roller bearing 38 arranged between two tapered roller bearings, with an outer ring 40, with an inner ring 42, with cylindrical rollers 44 arranged between the outer ring and the inner ring, and also a planet carrier 46. Between the planet carrier 46 and the inner ring 42 is arranged an eccentric ring 48 which is rotatable on the planet carrier 46 and as the result of the rotation of which the eccentricity of the radial bearing 38 with respect to the planet carrier 46 can be adjusted in the circumferential direction, and, consequently, the radial bearing 38 can be braced with respect to the tapered roller bearings.

### LIST OF REFERENCE SYMBOLS

2 planet carrier
4 planet gear
6 bearing arrangement
8 tapered roller bearing
8a inner ring of a tapered roller bearing
8b outer ring of a tapered roller bearing
8c rolling body of a tapered roller bearing
10 tapered roller bearing
12 radial bearing
12a inner ring of the radial bearing
12b outer ring of the radial bearing
12c rolling body of the radial bearing
14 bearing arrangement
16 tapered roller bearing
17 axis of rotation of the tapered rollers of 16
18 tapered roller bearing
19 axis of rotation of the tapered rollers of 18
20 radial bearing
22 outer ring
24 tapered roller bearing
28 tapered roller bearing
30 radial bearing
32 inner bearing ring
34 conical sleeve
36 arrow
38 cylindrical roller bearing
40 outer ring
42 inner ring
44 cylindrical rollers
46 planet carrier
48 eccentric ring
50 annular web of the planet wheel
52 surface area of the annular web
54 surface area of the outer ring of the radial bearing

1. A bearing arrangement for a rotatable mounting of a planet gear on a planet carrier, with two tapered roller bearings arranged with an axial spacing with respect to one another, wherein at least one radial bearing is arranged between the tapered roller bearings.

2. The bearing arrangement as claimed in claim 1, wherein the at least one radial bearing at least substantially fills the axial interspace between the tapered roller bearings.

3. The bearing arrangement as claimed in claim 1, wherein the tapered roller bearings are designed and arranged such that axes of rotation of the tapered rollers intersect one another between the tapered roller bearings and radially within raceways of the tapered rollers.

4. The bearing arrangement as claimed in claim 1, wherein the at least one radial bearing is a cylindrical roller bearing.

5. The bearing arrangement as claimed in claim 1, wherein the at least one radial bearing is a needle bearing.

6. The bearing arrangement as claimed in claim 1, wherein the at least one radial bearing is a ball bearing.

7. The bearing arrangement as claimed in claim 1, wherein an inner bearing ring of the radial bearing is adjustable in terms of bearing play or of bearing prestress.

8. The bearing arrangement as claimed in claim 7, wherein the inner face of the inner bearing ring of the radial bearing is designed conically and is seated on an axially displaceable sleeve having a complementarily conical outer face.

9. The bearing arrangement as claimed in claim 7, wherein the inner bearing ring of the radial bearing is seated on a rotatable eccentric ring.

10. The bearing arrangement as claimed in claim 1, wherein a radially inward-pointing annular web is formed on the planet gear, and a radially inward-pointing surface area of the radially inward-pointing annular web is supported on a radially outer surface area of an outer ring of the at least one radial bearing.

11. The bearing arrangement as claimed in claim 1, wherein the tapered roller bearings and the at least one radial bearing have a common outer ring.

12. The bearing arrangement as claimed in claim 1, wherein the at least one radial bearing is a plain bearing.

13. The bearing arrangement as claimed in claim 1, wherein the bearing arrangement is a component of an planetary gear stage of a wind turbine transmission arrangement.
